(19) United States
(12) Patent Application Publication
(10) Pub. No.: US 2016/0255872 A1
(43) Pub. Date: Sep. 8, 2016

(54) FOOD ADDITIVE, FOOD PACKAGING ADDITIVES, AND USES THEREOF

(71) Applicant: EMPIRE TECHNOLOGY DEVELOPMENT LLC, Wilmington, DE (US)

(72) Inventors: Georgius Abidal ADAM, Edensor Park, New South Wales (AU); Anita NEEDHAM, Wollongong, New South Wales (AU)

(73) Assignee: EMPIRE TECHNOLOGY DEVELOPMENT LLC, Wilmington, DE (US)

(21) Appl. No.: 15/032,040

(22) PCT Filed: Oct. 23, 2013
(86) PCT No.: PCT/US13/66343

§ 371 Date: Apr. 25, 2016

(51) Int. Cl. A23L 3/3517; C09K 5/06; A23G 1/32

(52) U.S. Cl. CPC A23L 3/3517; A23L 1/39; A23G 1/32; C09K 5/063; A23V 2002/00

(57) ABSTRACT

Food additives and food packaging materials having phase change materials are provided. Examples of phase change materials include gallic acid esters, tannic acid esters, fulvic acid, chitosan esters, hemicellulose derived esters, and the like. Methods of making and using the same are also provided.

### BACKGROUND

Improper temperature management can be a leading cause of food spoilage and may greatly deteriorate the overall quality of food. Some foods, such as bakery items, can be damaged at low temperatures or may tend to dry-out at warm temperatures. Other foods such as raw meats, seafood and certain confectionary products such as chocolates, cakes and pastries, can deteriorate in quality and taste in warm conditions and/or if they are improperly frozen. Few packaging solutions directly assist in effectively regulating temperatures to within an ideal temperature range. Solutions that do exist can be characterized as being bulky, expensive and impractical.

For thermostatic food packaging, a practical solution would be one that is inexpensive, and could be implemented easily and ubiquitously without the need for bulky external packaging layers. Additionally, if the temperature sensitive foods can be made thermostable without significant detectable taste, odor or aesthetic modification resulting from environmental temperature fluctuations, there can be greater flexibility for food producers in packaging, storing or transporting these foods.

The present disclosure overcomes the disadvantages as well as provides other advantages as discussed herein.

### SUMMARY

In some embodiments, a food item comprising a food additive, wherein the food additive comprises one or more phase change materials selected from a gallic acid ester, a tannic acid ester, a fulvic acid ester, a hemicellulose derived ester, or any combination thereof, wherein at least one hydroxyl group of a gallic acid, tannic acid, fulvic acid, hemicellulose, or any combination thereof, is esterified and at least one carboxyl group of the gallic acid, tannic acid, fulvic acid, hemicellulose or any combination thereof is esterified is provided.

In some embodiments, a food packaging material is provided. In some embodiments, the food packaging material comprises a food packaging additive, wherein the food packaging additive comprises one or more phase change materials selected from a gallic acid ester, a tannic acid ester, a fulvic acid ester, a hemicellulose derived ester, or any combination thereof, wherein the phase change material is configured to store or release energy to keep the food packaging material at a desired temperature, and wherein at least one hydroxyl group of a gallic acid, tannic acid, fulvic acid ester, hemicellulose, or any combination thereof, is esterified, and at least one carboxyl group of the gallic acid, fulvic acid, tannic acid, hemicellulose, or any combination thereof, is esterified.

In some embodiments, methods of preparing food items are provided. In some embodiments, the method comprises mixing a food item with a food additive, wherein the food additive comprises one or more phase change materials selected from a gallic acid ester, a tannic acid ester, a fulvic acid ester, a hemicellulose derived ester, or any combination thereof, wherein at least one hydroxyl group of a gallic acid, tannic acid, fulvic acid, hemicellulose, or any combination thereof, is esterified and at least one carboxyl group of the gallic acid, tannic acid, fulvic acid, hemicellulose or any combination thereof is esterified.

In some embodiments, methods of preparing a food packaging material are provided. In some embodiments, the method comprises mixing a polymer with a food packaging additive to form a mixture; and processing the mixture to form the food packaging material, wherein the food packaging additive comprises one or more phase change materials selected from a gallic acid ester, a tannic acid ester, a fulvic acid ester, a hemicellulose derived ester, or any combination thereof, wherein the phase change material is configured to store or release energy to keep the food packaging material at a desired temperature, and wherein at least one hydroxyl group of a gallic acid, tannic acid, fulvic acid ester, hemicellulose, or any combination thereof, is esterified, and at least one carboxyl group of the gallic acid, fulvic acid, tannic acid, hemicellulose, or any combination thereof, is esterified.

### DETAILED DESCRIPTION

This description is not limited to the particular processes, compositions, or methodologies described, as these may vary. The terminology used in the description is for the purpose of describing the particular versions or embodiments only, and it is not intended to limit the scope of the embodiments described herein. Unless defined otherwise, all technical and scientific terms used herein have the same meanings as commonly understood by one of ordinary skill in the art. In some cases, terms with commonly understood meanings are defined herein for clarity and/or for ready reference, and the inclusion of such definitions herein should not necessarily be construed to represent a substantial difference over what is generally understood in the art. However, in case of conflict, the patent specification, including definitions, will prevail.

It must also be noted that as used herein and in the appended claims, the singular forms “a”, “an”, and “the” include plural reference unless the context clearly dictates otherwise.

As used herein, the term “alkyl” means a saturated or unsaturated hydrocarbon group which is straight-chained or branched. An unsaturated alkyl group refers to an alkyl group that contains at least one double bond, which can also be referred to as an “alkenyl.” The alkyl chain can also be substituted. An alkyl group can contain from 1 to 24, from 1 to 22, from 1 to 20, from 1 to 18, from 1 to 16, from 1 to 14, from 1 to 12, from 2 to 20, from 1 to 10, from 2 to 10, from 1 to 8, from 2 to 8, from 1 to 6, from 2 to 6, from 1 to 4, from 2 to 4, from 1 to 3, or 2 or 3 carbon atoms. Examples of alkyl groups include, but are not limited to, methyl (Me), ethyl (Et), propyl (for example, n-propyl and isopropyl), butyl (for example, n-butyl, t-butyl, isobutyl), pentyl (for example, n-pentyl, isopentyl, neopentyl), hexyl, isohexyl, heptyl, 4,4 dimethylpentyl, octyl, 2,2,4-trimethylpentyl, nonyl, decyl, undecyl, dodecyl, 2-methyl-1-propyl, 2-methyl-2-propyl, 2-methyl-1-butyl, 3-methyl-1-butyl, 2-methyl-3-butyl, 2-methyl-1-pentyl, 2,2-dimethyl-1-propyl, 3-methyl-1-pentyl, 4-methyl-1-pentyl, 2-methyl-2-pentyl, 3-methyl-2-pentyl, 4-methyl-2-pentyl, 2,2-dimethyl-1-butyl, 3,3-dimethyl-1-butyl, 2-ethyl-1-butyl, and the like.

As used herein, the phrase “C₁-C₂₄ alkyl, optionally comprising at least one alkenyl group” refers to a C₁-C₂₄ alkyl carbon chain that can have at least one alkenyl group located anywhere in the chain. When the C₁-C₂₄ alkyl carbon chain has at least one alkenyl group, the length of the C₁-C₂₄ alkyl carbon chain is at least two carbons. When present, the carbons in the alkenyl group are counted as carbons in the C₁-C₂₄ alkyl carbon chain.

As used herein, the term “alkenyl” means a straight or branched alkyl group having one or more double carbon-carbon bonds and 2-20 carbon atoms, including, but not limited to, ethenyl, 1-propenyl, 2-propenyl, 2-methyl-1-propenyl, 1-butenyl, 2-butenyl, and the like. In some embodiments, the alkenyl chain is from 2 to 24 carbon atoms in length, from 2 to 22 carbon atoms in length, from 2 to 20 carbon atoms in length, from 2 to 18 carbon atoms in length, from 2 to 16 carbon atoms in length, from 2 to 14 carbon atoms in length, from 2 to 12 carbon atoms in length, from 2 to 10 carbon atoms in length, from 2 to 8 carbon atoms in length, from 2 to 6 carbon atoms in length, or from 2 to 4 carbon atoms in length. In some embodiments, the alkenyl group has 1, 2, 3, 4, 5, or 6 double bonds.

As used in this document, terms “comprise,” “have,” and “include” and their conjugates, as used herein, mean “including but not limited to.” While various compositions, methods, and devices are described in terms of “comprising” various components or steps (interpreted as meaning “including, but not limited to”), the compositions, methods, and devices can also “consist essentially of” or “consist of” the various components and steps, and such terminology should be interpreted as defining essentially closed-member groups.

Embodiments disclosed herein provide new phase change materials (PCMs) that are derived from food safe (GRAS approved) food ingredients such as gallic acid, tannic acid, hemicellulose (for example, xylitol, xyloglucan, and chitosan) and fulvic acid. In some embodiments, these materials have tailorable phase transition temperatures (above and below room temperature) with active gradient groups that have been known to have excellent energy storage characteristics. Other advantages of these materials include, but are not limited to, providing nutrition and/or health benefits. The materials described herein can be used as either food additives in food items or a food packaging additive in food packaging materials to keep the food items at the desired temperature for longer periods of time without external heating or cooling.

In some embodiments, food items that include at least one food additive are provided. In some embodiments, the food item is a baked food product, a chocolate product, a dairy product, a meat product, a poultry product, a seafood product, a vegetable product, a delicatessen product, a soup or a beverage. In some embodiments, the food additive may be present in the food item in an amount of about 1% to about 15% by weight of the food item. For example, the amount of food additive in the food item may be about 1% , about 5%, about 10%, about 15% by weight, or a percentage between any of these values.

In some embodiments, the food additive includes one or more phase change materials selected from a gallic acid ester, a tannic acid ester, a hemicellulose derived ester, a fulvic acid ester, or any combination thereof. In some embodiments, at least one hydroxyl group of a gallic acid, tannic acid, fulvic acid, hemicellulose, or any combination thereof can be esterified, and at least one carboxyl group of the gallic acid, tannic acid, hemicellulose, fulvic acid or any combination thereof, can be esterified. In some embodiments, the gallic acid ester, the tannic acid ester, the fulvic acid ester or the hemicellulose derived ester can be completely esterified. In some embodiments, the tannic acid ester is esterified with a gallic acid ester to form a tannic-gallic acid ester. A non-limiting example of a tannic-gallic acid ester is described in Example 4.

As used herein, the term “food additive” refers to any compound that can be safely added to food and be consumed by animals, such as humans or veterinary animals (for example, cats, dogs, horses, cows, pigs, chickens, fish, livestock, and the like).

As used herein, the term “completely esterified” refers to a compound where all of the side chains of molecule that can be esterified are esterified. Examples of side chains include, but are not limited to, carboxylate groups and hydroxyl groups. For example, all carboxylate groups can be esterified, all hydroxyl groups can be esterified, or all carboxylate groups and all hydroxyl groups can be esterified. Various combinations of compounds are described herein and in each of the combinations, each compound specifically recited can be completely esterified or partially esterified. Other embodiments and various combinations are also described herein and encompassed by the presently disclosed embodiments.

The hemicellulose derived ester can be any ester of any hemicellulose. In some embodiments, the hemicellulose is chitosan, xylitol, xyloglucan, or cyclodextrin. Accordingly, in some embodiments, the hemicellulose derived ester is one or more of a chitosan ester, xylitol ester, xyloglucan ester, or a cyclodextrin ester.

In some embodiments, the phase change material may include the gallic acid ester, and the xylitol ester. In some embodiments, at least one hydroxyl group of the gallic acid or the xylitol can be esterified and at least one carboxyl group of the gallic acid or the xylitol can be esterified. In some embodiments, the gallic acid ester can be completely esterified. In some embodiments, the xylitol acid ester can be completely esterified.

In some embodiments, the phase change material may include the gallic acid ester and the xyloglucan ester. In some embodiments, at least one hydroxyl group of the gallic acid or the xyloglucan can be esterified and the at least one carboxyl group of the gallic acid or the xyloglucan can be esterified. In some embodiments, the gallic acid ester can be completely esterified and the xyloglucan may not be completely esterified. In some embodiments, the xyloglucan can be completely esterified. In some embodiments, the xyloglucan can be completely esterified and the gallic ester cannot be completely esterified.

In some embodiments, the phase change material may include the gallic acid ester, and the chitosan ester. In some embodiments, at least one hydroxyl group of the gallic acid or the chitosan can be esterified and the at least one carboxyl group of the gallic acid or the chitosan can be esterified. In some embodiments, the gallic acid ester can be completely esterified and the chitosan may not be completely esterified. In some embodiments, the chitosan acid ester can be completely esterified. In some embodiments, the chitosan acid ester can be completely esterified and the gallic ester cannot be completely esterified.

In some embodiments, the phase change material may include the tannic acid ester and the xylitol ester. In some embodiments, at least one hydroxyl group of the tannic acid or the xylitol can be esterified and the at least one carboxyl group of the tannic acid or the xylitol can be esterified. In some embodiments, the tannic acid ester can be completely esterified and the xylitol may not be completely esterified. In some embodiments, the xylitol ester can be completely esterified. In some embodiments, the xylitol ester can be completely esterified and the tannic ester may not be completely esterified.

In some embodiments, the phase change material may include the tannic acid ester and the xyloglucan ester. In some embodiments, at least one hydroxyl group of the tannic acid or the xyloglucan can be esterified and the at least one carboxyl group of the tannic acid or the xyloglucan can be esterified. In some embodiments, the tannic acid ester can be completely esterified and the xyloglucan may not be completely esterified. In some embodiments, the xyloglucan ester can be completely esterified. In some embodiments, the xyloglucan ester can be completely esterified and the tannic ester may not be completely esterified.

In some embodiments, the phase change material may include the tannic acid ester and the chitosan ester. In some embodiments, at least one hydroxyl group of the tannic acid or the chitosan can be esterified and the at least one carboxyl group of the tannic acid or the chitosan can be esterified. In some embodiments, the tannic acid ester can be completely esterified and the chitosan may not be completely esterified. In some embodiments, the chitosan ester can be completely esterified. In some embodiments, the chitosan ester can be completely esterified and the tannic ester may not be completely esterified.

In some embodiments, the phase change material may include the cyclodextrin ester and a hydrogel. In some embodiments, the phase change material may include a completely esterified cyclodextrin ester and a hydrogel. In some embodiments, the cyclodextrin ester may not be completely esterified.

In some embodiments, the phase change material that is present in a food item can be a hydrogel. In some embodiments, the hydrogel may be an edible gelatin, a carboxy methylcellulose, a protein hydrogel, or any combination thereof.

In some embodiments, the phase change material may include one or more of a compound of:

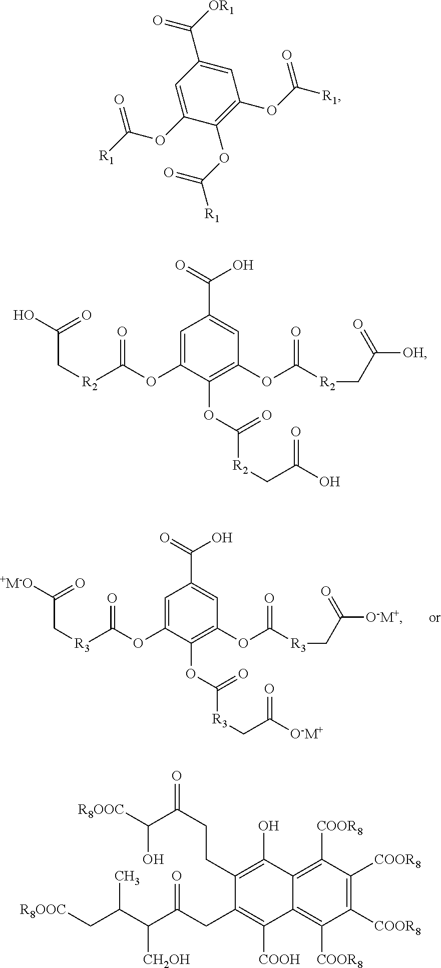

wherein:
R₁ is saturated C₁-C₂₄ alkyl or unsaturated C₁-C₂₄ alkyl;
R₂ is C₁-C₂₄ alkyl, or C₁-C₂₄ alkyl comprising at least one alkenyl group;
R₃ is C₁-C₂₄ alkyl, or C₁-C₂₄ alkyl comprising at least one alkenyl group;
R₈ is saturated C₁-C₂₄ alkyl or unsaturated C₁-C₂₄ alkyl; and
M is Na⁺, K⁺, Ca²⁺, Mg²⁺, Zn²⁺, or Fe⁺³.

In some embodiments, R₁, R₂, R₃, and R₈ are the same. In some embodiments, two of R₁, R₂, R₃, and R₈ are the same. In some embodiments, each of R₁, R₂, R₃, and R₈ are different. In some embodiments, R₁, R₂, R₃, and R₈ are each independently chosen from saturated C₁-C₂₄ alkyl or unsaturated C₁-C₂₄ alkyl, saturated C₁-C₂₀ alkyl or unsaturated C₁-C₂₀ alkyl, saturated C₁-C₁₈ alkyl or unsaturated C₁-C₁₈ alkyl, saturated C₁-C₁₆ alkyl or unsaturated C₁-C₁₆ alkyl, saturated C₁-C₁₄ alkyl or unsaturated C₁-C₁₄ alkyl, or saturated C₁-C₁₂ alkyl or unsaturated C₁-C₁₂ alkyl. In some embodiments, R₁, R₂, R₃, and R₈ are each independently chosen from C₁-C₂₄ alkenyl, C₁-C₂₀ alkenyl, C₁-C₁₈ alkenyl, C₁-C₁₆ alkenyl, C₁-C₁₄ alkenyl, or C₁-C₁₂ alkenyl. In some embodiments, R₈ is C₁₀H₂₁.

In some embodiments, the phase change material may include a compound of:

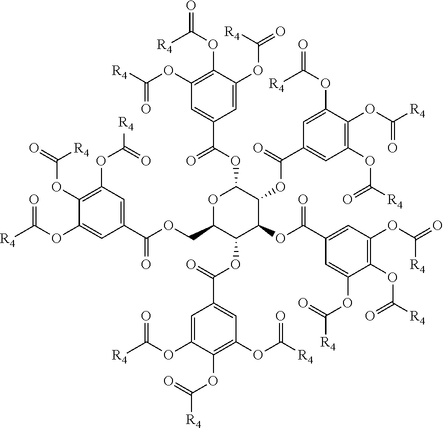

wherein:
R₄ is -(C₁-C₂₄)alkyl, -(C₁-C₂₄)C(═O)OH, -(C₁-C₂₄)O—C(=O)R₅, -(C₁-C₂₄)O—
C(═O)R₆C(═O)OH, or -(C₁-C₂₄)O—C(═O)R₇C(═O)O⁻M⁺;
R₅ is C₁-C₂₄ alkyl, or C₁-C₂₄ alkyl comprising at least one alkenyl group;
R₆ is C₁-C₂₄ alkyl, or C₁-C₂₄ alkyl comprising at least one alkenyl group;
R₇ is C₁-C₂₄ alkyl, or C₁-C₂₄ alkyl comprising at least one alkenyl group;
M is Na⁺, K⁺, Ca²⁺, Mg²⁺, Zn²⁺, or Fe³⁺.

In some embodiments, R₄ is saturated C₁-C₂₄ alkyl or unsaturated C₁-C₂₄ alkyl, saturated C₁-C₂₀ alkyl or unsaturated C₁-C₂₀ alkyl, saturated C₁-C₁₈ alkyl or unsaturated C₁-C₁₈ alkyl, saturated C₁-C₁₆ alkyl or unsaturated C₁-C₁₆ alkyl, saturated C₁-C₁₄ alkyl or unsaturated C₁-C₁₄ alkyl, or saturated C₁-C₁₂ alkyl or unsaturated C₁-C₁₂ alkyl. In some embodiments, R₄ is C₁-C₂₄ alkenyl, C₁-C₂₀ alkenyl, C₁-C₁₈ alkenyl, C₁-C₁₆ alkenyl, C₁-C₁₄ alkenyl, or C₁-C₁₂ alkenyl. In some embodiments, R₄ is -(C₁-C₂₄)C(═O) OH, wherein the C₁-C₂₄ can be saturated or unsaturated as described above.

In some embodiments, R₅, R₆, and R₇ are the same. In some embodiments, two of R₄, R₅, R₆, and R₇ are the same. In some embodiments each of R₅, R₆, and R₇ are different. In some embodiments, R₅, R₆, and R₇ are each independently chosen from saturated C₁-C₂₄ alkyl or unsaturated C₁-C₂₄ alkyl, saturated C₁-C₂₀ alkyl or unsaturated C₁-C₂₀ alkyl, saturated C₁-C₁₈ alkyl or unsaturated C₁-C₁₈ alkyl, saturated C₁-C₁₆ alkyl or unsaturated C₁-C₁₆ alkyl, saturated C₁⁻C₁₄ alkyl or unsaturated C₁-C₁₄ alkyl, or saturated C₁-C₁₂ alkyl or unsaturated C₁-C₁₂ alkyl. In some embodiments, R₅, R₆, and R₇ are each independently chosen from C₁-C₂₄ alkenyl, C₁-C₂₀ alkenyl, C₁-C₁₈ alkenyl, C₁-C₁₆ alkenyl, C₁-C₁₄ alkenyl, or C₁-C₁₂ alkenyl.

Embodiments described herein also provide food packaging materials that include a food packaging additive, wherein the food packaging additive includes one or more phase change materials selected from a gallic acid ester, a tannic acid ester, a fulvic acid ester, a hemicellulose derived ester or any combination thereof, and wherein the phase change material is configured to store or release an energy to keep the food packaging material at a desired temperature. In some embodiments, at least one hydroxyl group of a gallic acid, tannic acid, fulvic acid, hemicellulose, or any combination thereof can be esterified and the at least one carboxyl group of the gallic acid, tannic acid, fulvic acid, hemicellulose, or any combination thereof can be esterified. In some embodiments, the food packaging material may be a film, a box, a bag, a pouch, a tray, a canister, a vial, or a carton. In some embodiments, the food packaging additive may be present in the food packaging material in an amount of about 1% to about 30% by weight. For example, the amount of food additive present in the food packaging material may be about 1%, about 5%, about 10%, about 15%, about 20%, about 25%, about 30% by weight, or a percentage between any of these values. In some embodiments, the food packaging material may further include at least one polymer. The polymer may be safe for contacting with food items, and can for example, be polyvinylacetate, cellulose acetate, or polyester, or a combination thereof. In some embodiments, the polymer may be present in the food packaging material in an amount of about 70% to about 99% by weight of the food packaging material. For example, the amount of polymer in the food packaging material may be about 70%, about 75%, about 80%, about 85%, about 90%, about 95%, about 99%, by weight, or a percentage between any of these values.

In some embodiments, the food packaging material may include a hemicellulose derived ester, wherein the hemicellulose derived ester may be one or more of a xylitol ester, a xyloglucan ester, a chitosan ester, or a cyclodextrin ester. The esters can be completely esterified or not completely esterified.

In some embodiments, the food packaging material may include a phase change material that includes the gallic acid ester and the xylitol ester. In some embodiments, the phase change material may include the gallic acid ester and/or the xyloglucan ester. In some embodiments, the phase change material may include the gallic acid ester and the chitosan ester. In some embodiments, the phase change material may include the tannic acid ester and the xylitol ester. In some embodiments, the phase change material may include the tannic acid ester and the xyloglucan ester. In some embodiments, the phase change material may include the tannic acid ester and the chitosan ester.

In some embodiments, the food packaging materials may include a phase change material that includes one or more of a compound of:

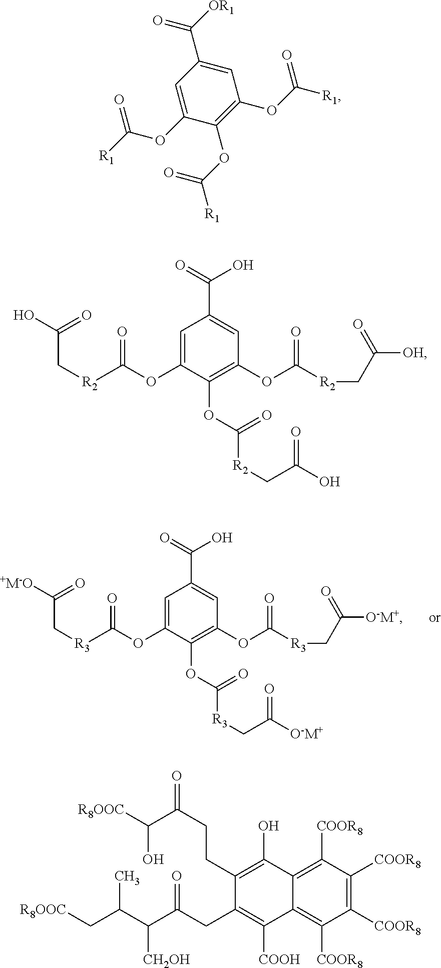

wherein:
R₁ is saturated C₁-C₂₄ alkyl or unsaturated C₁-C₂₄ alkyl;
R₂ is C₁-C₂₄ alkyl, or C₁-C₂₄ alkyl comprising at least one alkenyl group;
R₃ is C₁-C₂₄ alkyl, or C₁-C₂₄ alkyl comprising at least one alkenyl group;
R₈ is saturated C₁-C₂₄ alkyl or unsaturated C₁-C₂₄ alkyl; and
M is Na⁺, K⁺, Ca²⁺, Mg²⁺, Zn²⁺, or Fe⁺³.

In some embodiments, R₁, R₂, R₃, and R₈ are the same. In some embodiments, two of R₁, R₂, R₃, and R₈ are the same. In some embodiments, each of R₁, R₂, R₃, and R₈ are different. In some embodiments, R₁, R₂, R₃, and R₈ are each independently chosen from saturated C₁-C₂₄ alkyl or unsaturated C₁-C₂₄ alkyl, saturated C₁-C₂₀ alkyl or unsaturated C₁-C₂₀ alkyl, saturated C₁-C₁₈ alkyl or unsaturated C₁-C_{˜}alkyl, saturated C₁-C₁₆ alkyl or unsaturated C₁-C₁₆ alkyl, saturated C₁-C₁₄ alkyl or unsaturated C₁-C₁₄ alkyl, or saturated C₁-C₁₂ alkyl or unsaturated C₁-C₁₂ alkyl. In some embodiments, R₁, R₂, R₃, and R₈ are each independently chosen from C₁-C₂₄ alkenyl, C₁-C₂₀ alkenyl, C₁-C₁₈ alkenyl, C₁-C₁₆ alkenyl, C₁-C₁₄ alkenyl, or C₁-C₁₂ alkenyl. In some embodiments, R₈ is C₁₀H₂₁.

In some embodiments of the food packaging material, the phase change material may include a compound of:

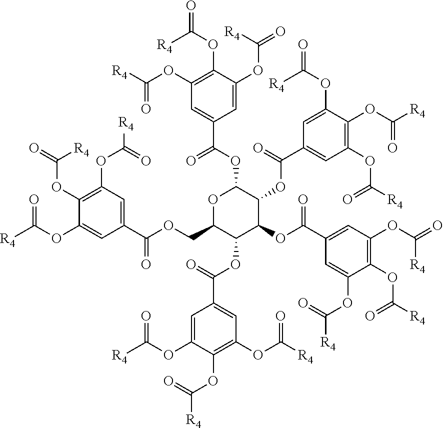

wherein:
R₄ is -(C₁-C₂₄)alkyl, -(C₁-C₂₄)C(═O)OH, -(C₁-C₂₄)O -C(═O)R₅, -(C₁-C₂₄)O-
C(≡O)R₆C(═O)OH, or -(C₁-C₂₄)O—C(═O)R₇C(═O)O⁻M⁺;
R₅ is C₁-C₂₄ alkyl, or C₁-C₂₄ alkyl comprising at least one alkenyl group;
R₆ is C₁-C₂₄ alkyl, or C₁-C₂₄ alkyl comprising at least one alkenyl group;
R₇ is C₁-C₂₄ alkyl, or C₁-C₂₄ alkyl comprising at least one alkenyl group; and
M is Na⁺, K⁺, Ca²⁺, Mg²⁺, Zn²⁺, or Fe³⁺.

In some embodiments, R₄ is saturated C₁-C₂₄ alkyl or unsaturated C₁-C₂₄ alkyl, saturated C₁-C₂₀ alkyl or unsaturated C₁-C₂₀ alkyl, saturated C₁-C₁₈ alkyl or unsaturated C₁-C₁₈ alkyl, saturated C₁-C₁₆ alkyl or unsaturated C₁-C₁₆ alkyl, saturated C₁-C₁₄ alkyl or unsaturated C₁-C₁₄ alkyl, or saturated C₁-C₁₂ alkyl or unsaturated C₁-C₁₂ alkyl. In some embodiments, R₄ is C₁-C₂₄ alkenyl, C₁-C₂₀ alkenyl, C₁-C₁₈ alkenyl, C₁-C₁₆ alkenyl, C₁-C₁₄ alkenyl, or C₁-C₁₂ alkenyl. In some embodiments, R₄ is -(C₁-C₂₄)C(═O) OH, wherein the C₁-C₂₄ can be saturated or unsaturated as described above.

In some embodiments, R₅, R₆, and R₇ are the same. In some embodiments, two of R₄, R₅, R₆, and R₇ are the same. In some embodiments each of R₅, R₆, and R₇ are different. In some embodiments, R₅, R₆, and R₇ are each independently chosen from saturated C₁-C₂₄ alkyl or unsaturated C₁-C₂₄ alkyl, saturated C₁-C₂₀ alkyl or unsaturated C₁-C₂₀ alkyl, saturated C₁-C₁₈ alkyl or unsaturated C₁-C₁₈ alkyl, saturated C₁-C₁₆ alkyl or unsaturated C₁-C₁₆ alkyl, saturated C₁⁻C₁₄ alkyl or unsaturated C₁-C₁₄ alkyl, or saturated C₁-C₁₂ alkyl or unsaturated C₁-C₁₂ alkyl. In some embodiments, R₅, R₆, and R₇ are each independently chosen from C₁-C₂₄ alkenyl, C₁-C₂₀ alkenyl, C₁-C₁₈ alkenyl, C₁-C₁₆ alkenyl, C₁-C₁₄ alkenyl, or C₁-C₁₂ alkenyl.

As described herein, the phase change material may be selected from a gallic acid ester, a tannic acid ester, a fulvic acid ester, a hemicellulose derived ester, or any combination thereof.

In some embodiments, the fulvic acid ester has a structure of

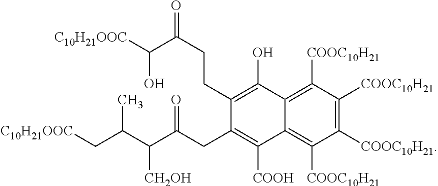

In some embodiments, the gallic acid ester has a structure of

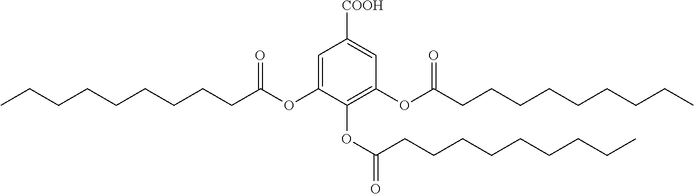 [SMILES: CCCCCCCCCC(=O)Oc1cc(C(=O)O)cc(OC(=O)CCCCCCCCC)c1OC(=O)CCCCCCCCC]

In some embodiments, the tannic acid ester has a structure of

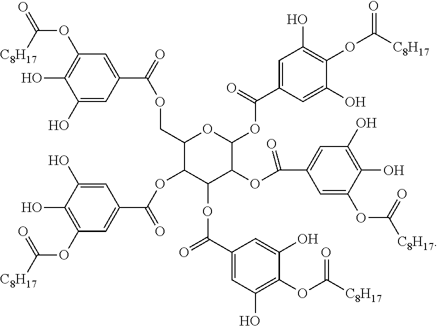

In some embodiments, the tannic acid ester has a structure of

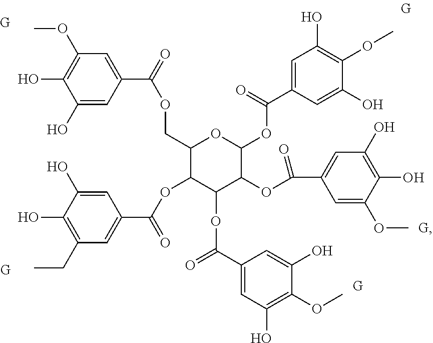 [SMILES: CCc1cc(C(=O)OC2C(COC(=O)c3cc(O)c(O)c(OC)c3)OC(OC(=O)c3cc(O)c(OC)c(O)c3)C(OC(=O)c3cc(O)c(O)c(OC)c3)C2OC(=O)c2cc(O)c(OC)c(O)c2)cc(O)c1O]

wherein G is

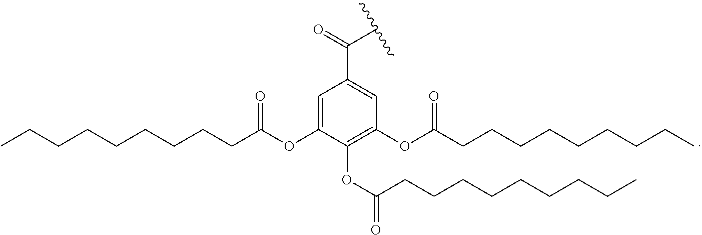 [SMILES: *C(=O)c1cc(OC(=O)CCCCCCCCC)c(OC(=O)CCCCCCCCC)c(OC(=O)CCCCCCCCC)c1]

In some embodiments of the food packaging material, the packaging material may further include at least one food item. The food item can be any food item that is suitable for the food packaging material including, but are not limited to, the food items described herein. In some embodiments, the food item can be a baked food product, a chocolate product, a dairy product, a meat product, a poultry product, a seafood product, a vegetable product, a delicatessen product, a soup, or a beverage. The food item can also include a phase change material as described herein.

The phase change materials as described herein can be made according to known methods. For example, the starting materials, such as, gallic acid, tannic acid, fulvic acid or hemicellulose can be esterified according to known methods. Non-limiting examples of the methods to make the phase change materials are described in the Example section below.

Methods of preparing food items are provided. In some embodiments, the methods include mixing a food item with a food additive, wherein the food additive includes one or more the phase change materials as described herein. In some embodiments, the mixing may include adding the food additive in an amount of about 1% to about 15% by weight of the food item or in amounts as described herein. The food item can be any one of those as described herein, and can then be pressed, baked, or made according to commonly known methods. The food additive that includes the one or more phase change materials can be used like any other ingredient used to make food and be added to a mixture of ingredients that are used to make the food.

Methods of making food packaging materials are provided. In some embodiments, the method of preparing a food packaging may include mixing a polymer as described herein with a food packaging additive to form a mixture; and processing the mixture to form the food packaging material, wherein the food packaging additive includes one or more phase change materials selected from a gallic acid ester, a tannic acid ester, a fulvic acid ester, a hemicellulose derived ester, or any combination thereof, wherein the phase change material is configured to store or release energy to keep the food packaging material at a desired temperature, and wherein at least one hydroxyl group of a gallic acid, tannic acid, fulvic acid ester, hemicellulose, or any combination thereof, is esterified, and at least one carboxyl group of the gallic acid, fulvic acid, tannic acid, hemicellulose, or any combination thereof, is esterified. In some embodiments, the polymer is polyvinylacetate, cellulose acetate, or polyester, or a combination thereof. The phase change material can be any phase change material suitable for a food packaging material such as, but not limited to, the phase change materials described herein. In some embodiments, processing the mixture may include injection molding, extruding, or film forming the mixture to form the food packaging material. Various food packaging materials can be prepared according to these methods, including, but not limited to, the food packaging items as described herein. In some embodiments, the food packaging material prepared according to the methods described herein can be a film, a box, a bag, a pouch, a tray, a canister, a vial, or a carton. In some embodiments, the food packaging material can be a film. In some embodiments, the mixing may include adding the food packaging additive in an amount of about 1% to about 30% by weight of the mixture or in amounts as described herein. In some embodiments, the mixing may include adding the polymer in an amount of about 70% to about 99% by weight of the mixture or in amounts as described herein.

### EXAMPLES

### Example 1

### Preparation of a Gallic Acid Caproate Ester PCM

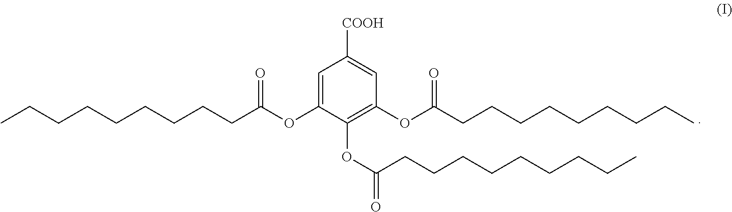 [SMILES: CCCCCCCCCC(=O)Oc1cc(C(=O)O)cc(OC(=O)CCCCCCCCC)c1OC(=O)CCCCCCCCC]

Gallic acid ester of formula (I) is prepared as follows. 114 grams (1 mol) of food grade caproic acid, gallic acid (43 grams, 0.25 mol), and anhydrous phosphoric acid (5 grams) are charged to a four-necked, 500-mL round-bottom flask fitted with a nitrogen spurge leg, thermometer, magnetic stirrer, and a rectifying column. The flask is heated to about 80° C. at which the caproic acid melts. The gallic acid is suspended in the melt under a subtle nitrogen sparge with constant agitation. Water from the reaction is liberated throughout the reaction and is continuously removed via the rectifying column The suspended gallic acid is gradually converted to the caproate esters. The reaction is terminated after 16 hours by stopping the heat input and cooling. The unreacted gallic acid is extracted with 10% w/v sodium carbonate The viscous gallic acid ester is washed with water and dried under vacuum. The dried gallic acid ester can be used as a phase change material.

### Example 2

### Preparation of Decyl Fulvate Ester PCM

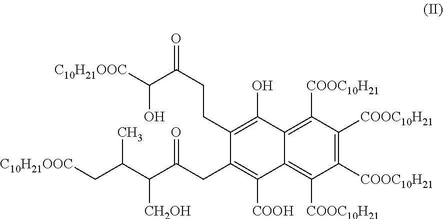

The decyl fulvate ester PCM material of formula (II) is made using a similar method as described in Example 1. The reaction vessel described in Example 1 is charged with 158 g decanol (1 mol) to which 63.8 g of solid fulvic acid and 3 g of hydrochloric acid are added. The mixture is heated to about 80° C. After completion of the reaction the solid suspension of fulvic acid is converted to a viscous product soluble in the decanol. The product is poured into 250 g of boiling water with mixing. The unreacted decanol is soluble in the boiling water. The oily layer, which contains the fulvic acid ester, is separated from the aqueous layer and dried under vacuum. The unreacted decanol can be separated from the hot water and reused as it has low solubility in cold water. The fulvic acid ester can be used as a phase change material.

### Example 3

### Preparation of Penta-Nonoyl Ester of Tannic Acid

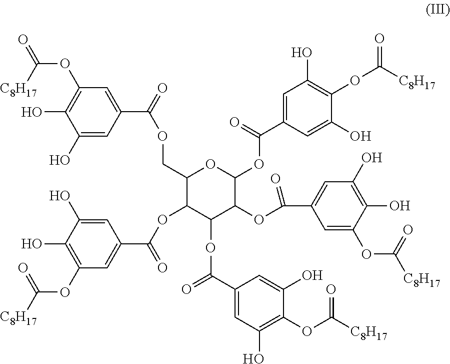

The tannic acid ester of formula (III) above is made according to the method described in Example 1. The reaction vessel as described in Example 1 is charged with nonanoic acid (267 grams, 1.5 moles), tannic acid (141 grams, 0.15 moles) and ortho-phosphorous acid (anhydrous) (5 grams) with a nitrogen sparge leg, thermometer, magnetic stirrer, and a rectifying column The flask is heated to about 80° C. under a subtle nitrogen sparge with constant agitation. The fatty acid melts with tannic acid as a suspension. As the reaction proceeds the tannic acid is converted to its ester derivative. Water from the reaction is liberated throughout the reaction and is continuously removed via the rectifying column The reaction is terminated after 16 hours by stopping the heat input and cooling. The unreacted nonanoic acid is extracted with 10% w/v sodium carbonate. The viscous/semisolid tannic ester is washed with water and dried under vacuum.

### Example 4

### Preparation of Tannin Penta-Gallate Ester Phase Change Material

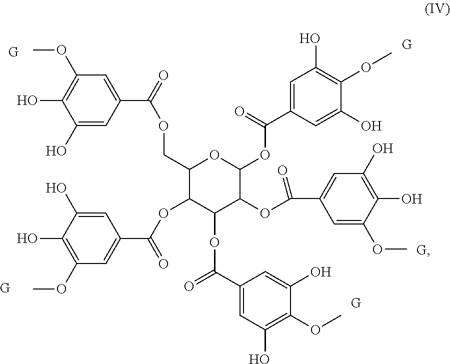 [SMILES: COc1cc(C(=O)OCC2OC(OC(=O)c3cc(O)c(OC)c(O)c3)C(OC(=O)c3cc(O)c(O)c(OC)c3)C(OC(=O)c3cc(O)c(OC)c(O)c3)C2OC(=O)c2cc(O)c(O)c(OC)c2)cc(O)c1O]

wherein G is

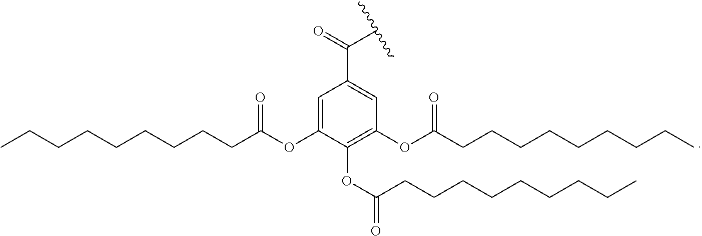 [SMILES: *C(=O)c1cc(OC(=O)CCCCCCCCC)c(OC(=O)CCCCCCCCC)c(OC(=O)CCCCCCCCC)c1]

The compound of formula (IV) is prepared according to a similar method as described in Example 1. A reaction vessel similar to that described in Example 1 is charged with the gallate tri-ester prepared in Example 1 and tannic acid in molar ratio 5:1 and with anhydrous ortho-phosphorous acid (0.01 mole) to a four-necked, 500-mL round-bottom flask fitted with a nitrogen sparge leg, thermometer, magnetic stirrer, and a rectifying column. The flask is heated to about 80° C. under a subtle nitrogen sparge with constant agitation. The gallate tri-ester melts with tannic acid as a suspension. As the reaction proceeds the tannic acid is converted to its ester derivative, the structure of which is shown in formula (IV) above. Water from the reaction is liberated throughout the reaction and is continuously removed via the rectifying column. The reaction is terminated after 16 hours by stopping the heat input and cooling. The unreacted gallate tri-ester does not need to be removed because it can also be used as a phase change material. The viscous, semisolid tannic ester is washed with water and dried under vacuum.

### Example 5

### Use of Gallic Acid Derivatives as PCM for Soup Product

A commercial soup powder is mixed with the gallic acid ester PCM as prepared in Example 1 to an amount equaling 2% of the total weight of the soup powder. Hot water is added to prepare the soup. The rate of cooling of the soup containing the gallic acid PCM is lower than a soup not containing the gallic acid ester PCM. This allows the heated soup containing PCM to remain at desirably hot temperatures for a longer period of time than with soup lacking the PCM.

### Example 6

### Use of Fulvic Acid Derivatives as PCM for Snack Bars

A snack bar is prepared by mixing 1 kg chopped peanuts, 1 kg chopped cashews, 500 grams raisins, 500 grams chocolate bits, 250 grams flaked coconut, and 100 grams of the decyl fulvate ester PCM as prepared in Example 2. The mixture is pressed into the desired rectangular bar shape. The snack bar is able to maintain its original temperature for a longer period of time than a snack bar without the decyl fulvate ester PCM. Additionally, the snack bar has enhanced nutritional value due to the antioxidant properties of the decyl fulvate PCM.

### Example 7

### Use of Polyvinylacetate Food Packaging Containing PCM for Hot Sandwiches

Polyvinylacetate is mixed with a PCM, such as those described in Examples 1-4, where the PCM is 5% of the final weight. The polyvinylacetate-PCM mixture is extruded to form films for food packaging. The films are used for wrapping hot sandwiches. The cooling rate for the sandwich wrapped in the polyvinylacetate-PCM film is lower than a sandwich wrapped in a polyvinylacetate film.

From the foregoing, it will be appreciated that various embodiments of the present disclosure have been described herein for purposes of illustration, and that various modifications may be made without departing from the scope and spirit of the present disclosure. Accordingly, the various embodiments disclosed herein are not intended to be limiting.

1. A food item comprising a food additive, wherein the food additive comprises two or more phase change materials selected from a gallic acid ester, a tannic acid ester, a fulvic acid ester, a hemicellulose derived ester, or any combination thereof, wherein at least one hydroxyl group and at least one carboxyl group of a gallic acid, tannic acid, fulvic acid, hemicellulose, or any combination thereof, is esterified.

2. (canceled)

3. The food item of claim 1, wherein the food item is a baked food product, a chocolate product, a dairy product, a meat product, a poultry product, a seafood product, a vegetable product, a delicatessen product, a soup, or a beverage.

4. The food item of claim 1, wherein the hemicellulose derived ester is one or more of a chitosan ester, xylitol ester, xyloglucan ester, or a cyclodextrin ester.

5. The food item of claim 4, wherein the phase change material comprises the gallic acid ester and one or more of the xylitol ester, xyloglucan ester and chitosan ester.

6-7. (canceled)

8. The food item of claim 4, wherein the phase change material comprises the tannic acid ester and the one or more of xylitol ester, xyloglucan ester and chitosan ester.

9-10. (canceled)

11. The food item of claim 4, wherein one of the two or more phase change materials comprises cyclodextrin ester and a hydrogel.

12. The food item of claim 1, wherein the phase change material comprises two or more of a compound of: 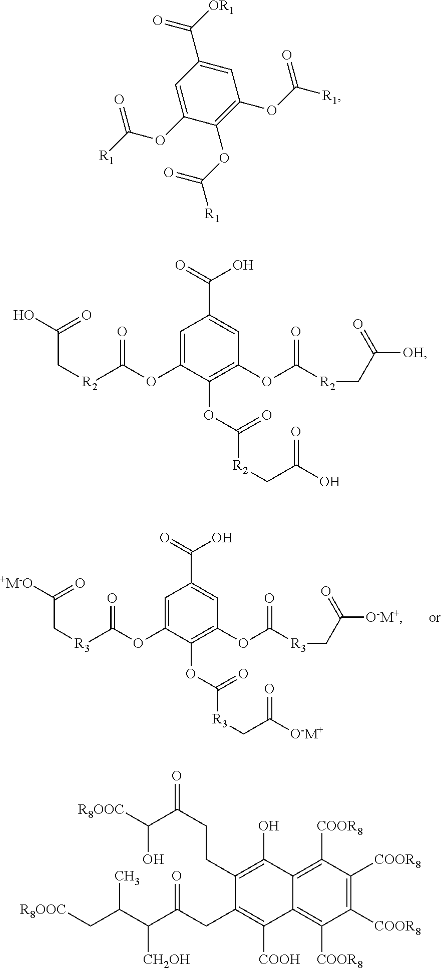
wherein:
R₁ is saturated C₁-C₂₄ alkyl or unsaturated C₁-C₂₄ alkyl;
R₂ is C₁-C₂₄ alkyl, or C₁-C₂₄ alkyl comprising at least one alkenyl group;
R₃ is C₁-C₂₄ alkyl, or C₁-C₂₄ alkyl comprising at least one alkenyl group;
R₈ is saturated C₁-C₂₄ alkyl or unsaturated C₁-C₂₄ alkyl; and
M is Na⁺, K⁺, Ca²⁺, Mg²⁺, Zn²⁺, or Fe⁺³.

13. The food item of claim 1, wherein one of the two or more the phase change materials comprises a compound of: 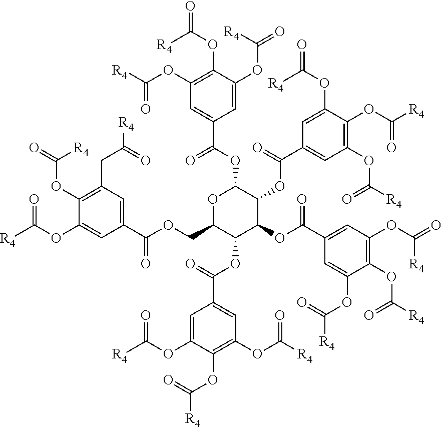
wherein:
R₄ is -(C₁-C₂₄)alkyl, -(C₁-C₂₄)C(═O)OH, -(C₁-C₂₄)O—C(═O)R₅, -(C₁-C₂₄)O—C(═O)R₆C(═O)OH, or -(C₁-C₂₄)O—C(═O)R₇C(═O)O⁻M⁺;
R₅ is C₁-C₂₄ alkyl, or C₁-C₂₄ alkyl comprising at least one alkenyl group;
R₆ is C₁-C₂₄ alkyl, or C₁-C₂₄ alkyl comprising at least one alkenyl group;
R₇ is C₁-C₂₄ alkyl, or C₁-C₂₄ alkyl comprising at least one alkenyl group;
M is Na⁺, K⁺, Ca²⁺, Mg²⁺, Zn²⁺, or Fe³⁺.

14. The food item of claim 1, wherein the two or more phase change materials comprise a hydrogel including an edible gelatin, a carboxy methylcellulose, a protein hydrogel, or any combination thereof.

15. (canceled)

16. The food item of claim 1, wherein at least one of the two or more phase change materials is a compound selected from the group consisting of: 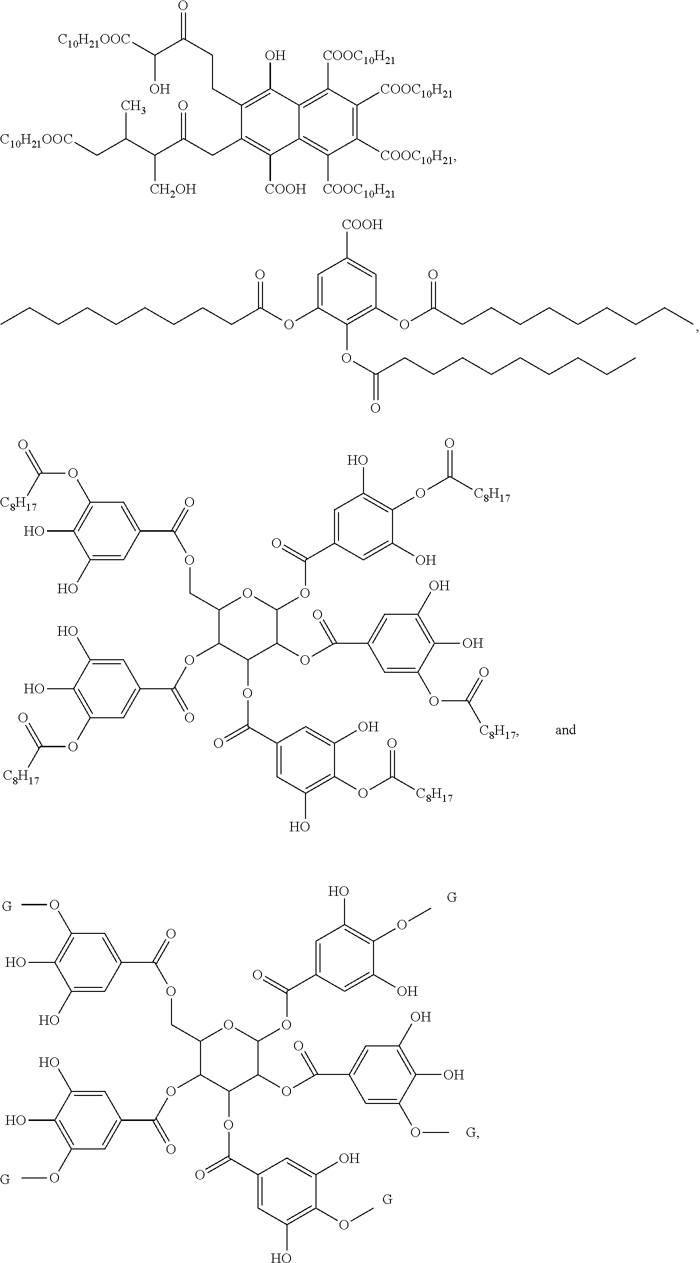
wherein G is

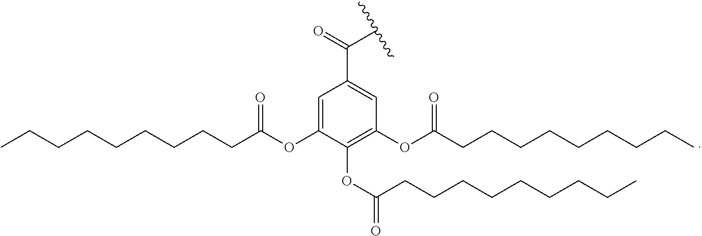 [SMILES: *C(=O)c1cc(OC(=O)CCCCCCCCC)c(OC(=O)CCCCCCCCC)c(OC(=O)CCCCCCCCC)c1]

17. The food item of claim 1, wherein the food additive is present in the food item in an amount of about 1% to about 15% by weight.

18. A food packaging material comprising a food packaging additive, wherein the food packaging additive comprises one or more phase change materials selected from a gallic acid ester, a tannic acid ester, a fulvic acid ester, a hemicellulose derived ester, or any combination thereof, wherein the phase change material is configured to store or release energy to keep the food packaging material at a desired temperature, and wherein at least one hydroxyl group of a gallic acid, tannic acid, fulvic acid ester, hemicellulose, or any combination thereof, is esterified, and at least one carboxyl group of the gallic acid, fulvic acid, tannic acid, hemicellulose, or any combination thereof, is esterified.

19. The food packaging material of claim 18, wherein the hemicellulose derived ester is one or more of a xylitol ester, a xyloglucan ester, a chitosan ester, or a cyclodextrin ester.

20. The food packaging material of claim 19, wherein the phase change material comprises the gallic acid ester and the xylitol ester.

21. The food packaging material of claim 19, wherein the phase change material comprises the gallic acid ester and one or more of the xyloglucan ester and the chitosan ester.

22. (canceled)

23. The food packaging material of claim 19, wherein phase change material comprises the tannic acid ester and one or more of the xylitol ester, the xyloglucan ester and the chitosan ester.

24-25. (canceled)

26. The food packaging material of claim 18, wherein the phase change material comprises one or more of a compound of: 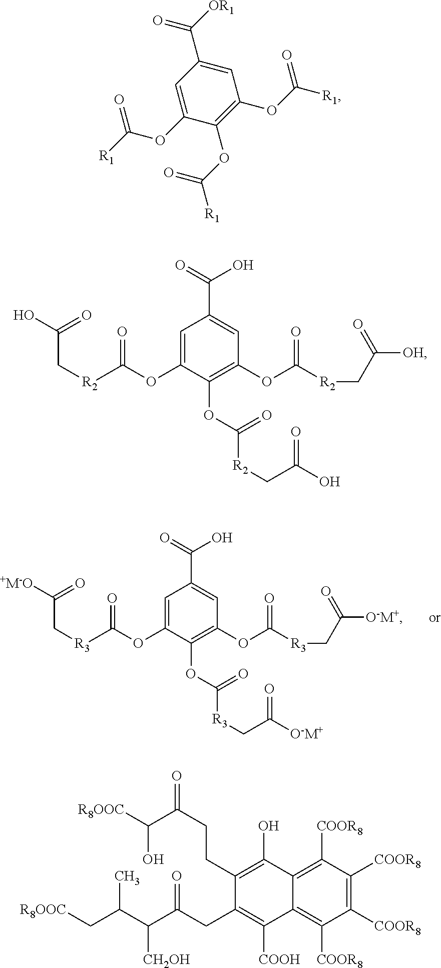
wherein:
R₁ is saturated C₁-C₂₄ alkyl or unsaturated C₁-C₂₄ alkyl;
R₂ is C₁-C₂₄ alkyl, or C₁-C₂₄ alkyl comprising at least one alkenyl group;
R₃ is C₁-C₂₄ alkyl, or C₁-C₂₄ alkyl comprising at least one alkenyl group;
R_{g} is saturated C₁-C₂₄ alkyl or unsaturated C₁-C₂₄ alkyl; and
M is Na⁺, K+, ca²⁺, Mg²⁺, Zn²⁺, or Fe⁺³.

27. The food packaging material of claim 18, wherein the phase change material comprises a compound of: 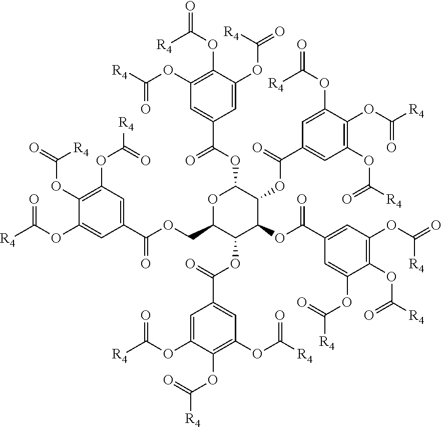
wherein:
R₄ is -(C₁-C₂₄)alkyl, -(C₁-C₂₄)C(═O)OH, -(C₁-C₂₄)O—C(═O)R₅, -(C₁-C₂₄)O—C(═O)R₆C(═O)OH, or -(C₁-C₂₄)O—C(═O)R₇C(═O)O⁻M⁺;
R₅ is C₁-C₂₄ alkyl, or C₁-C₂₄ alkyl comprising at least one alkenyl group;
R₆ is C₁-C₂₄ alkyl, or C₁-C₂₄ alkyl comprising at least one alkenyl group;
R₇ is C₁-C₂₄ alkyl, or C₁-C₂₄ alkyl comprising at least one alkenyl group; and
M is Na⁺, K+, Ca²⁺, Mg²⁺, Zn²⁺, or Fe⁺³. or Fe⁺³.

28. The food packaging material of claim 18, wherein the phase change material is a compound selected from the group consisting of: 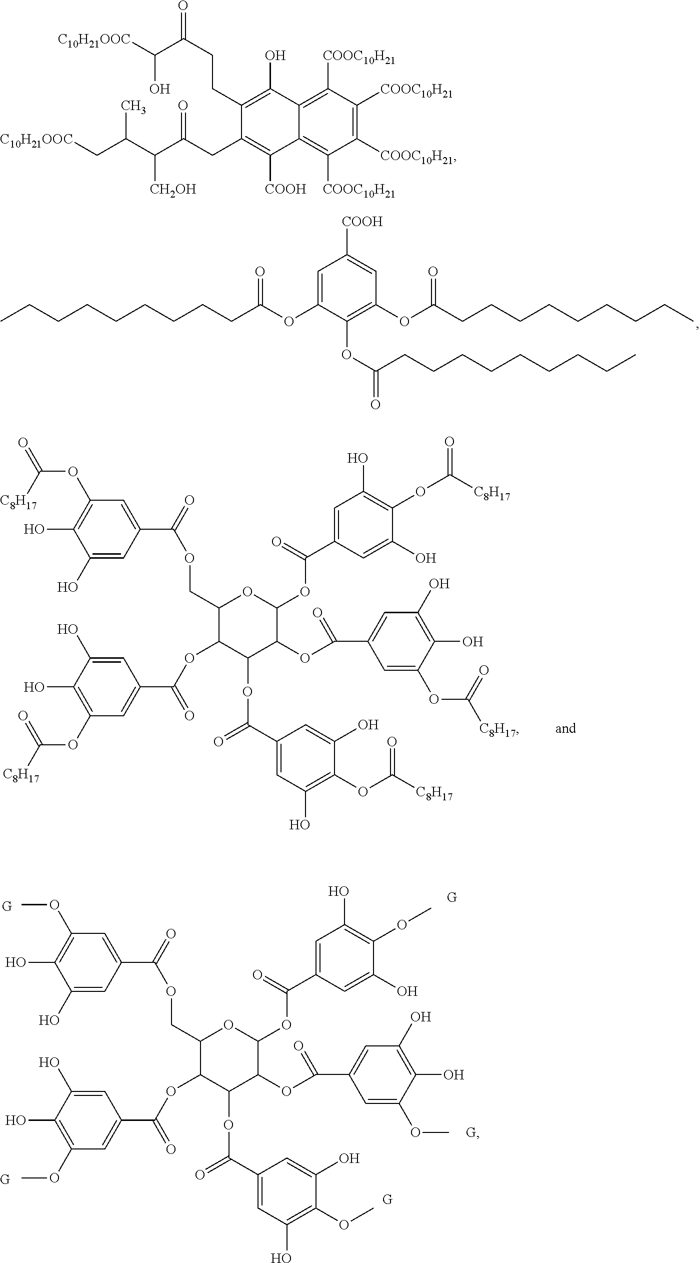
wherein G is

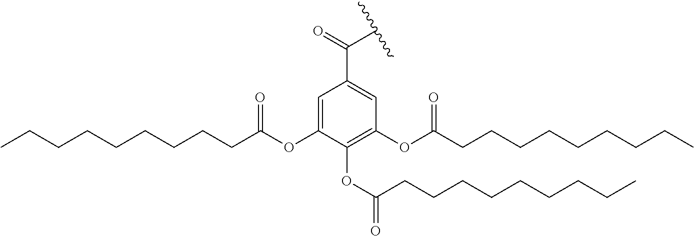 [SMILES: *C(=O)c1cc(OC(=O)CCCCCCCCC)c(OC(=O)CCCCCCCCC)c(OC(=O)CCCCCCCCC)c1]

29-32. (canceled)

33. The food packaging material of claim 18, wherein the food packaging material is a film, a box, a bag, a pouch, a tray, a canister, a vial, or a carton.

34. The food packaging material of claim 18, wherein the food packaging additive is present in the food packaging material in an amount of about 1% to about 30% by weight.

35. The food packaging material of claim 18, further comprising a polymer present in an amount of about 70% to about 99% by weight of the food packaging material.

36-45. (canceled)

46. A method of preparing a food packaging material, the method comprising:
mixing a polymer with a food packaging additive to form a mixture; and
processing the mixture to form the food packaging material, wherein the food packaging additive comprises one or more phase change materials selected from a gallic acid ester, a tannic acid ester, a fulvic acid ester, a hemicellulose derived ester, or any combination thereof,
wherein the phase change material is configured to store or release energy to keep the food packaging material at a desired temperature, and
wherein at least one hydroxyl group of a gallic acid, tannic acid, fulvic acid ester, hemicellulose, or any combination thereof, is esterified, and at least one carboxyl group of the gallic acid, fulvic acid, tannic acid, hemicellulose, or any combination thereof, is esterified.

47. The method of claim 46, wherein the mixing comprises mixing with a phase change material including one or more of a compound of: 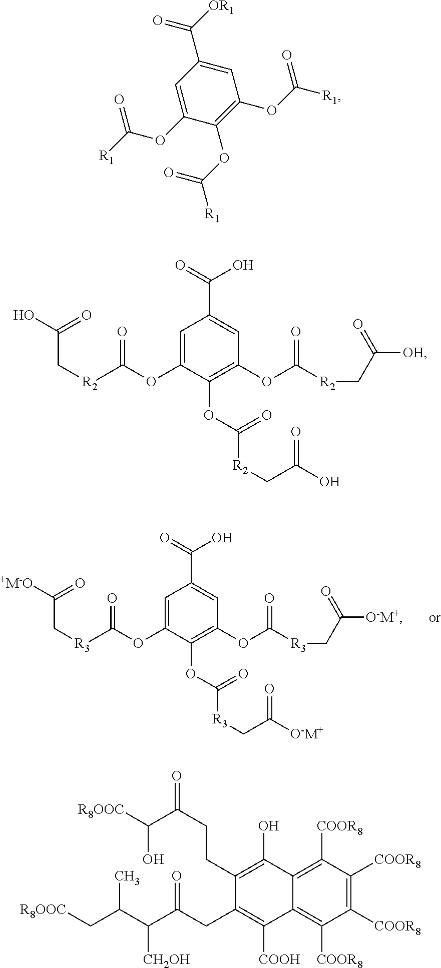
wherein:
R₁ is saturated C₁-C₂₄ alkyl or unsaturated C₁-C₂₄ alkyl;
R₂ is C₁-C₂₄ alkyl, or C₁-C₂₄ alkyl comprising at least one alkenyl group;
R₃ is C₁-C₂₄ alkyl, or C₁-C₂₄ alkyl comprising at least one alkenyl group;
R₈ is saturated C₁-C₂₄ alkyl or unsaturated C₁-C₂₄ alkyl; and
M is Na^{'}, K⁺, Ca²⁺, Mg²⁺, Zn²⁺, or Fe⁺³.

48. The method of claim 46, wherein the mixing comprises mixing with a phase change material including a compound of: 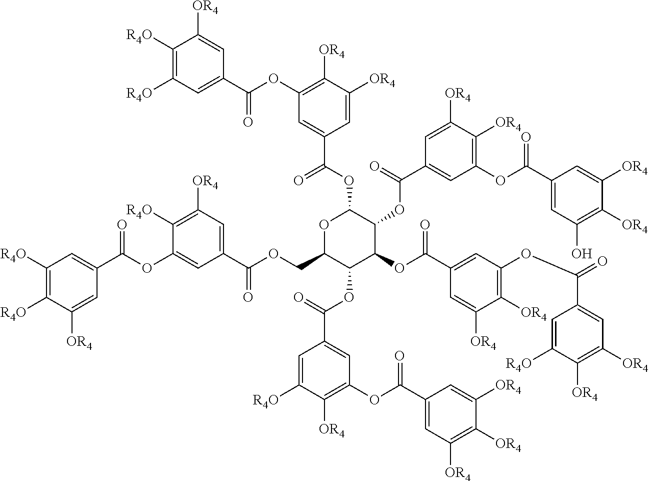
wherein:
R₄ is -(C₁-C₂₄)alkyl, -(C₁-C₂₄)C(═O)OH, -(C₁-C₂₄)O—C(═O)R₅, -(C₁-C₂₄)O—C(═O)R₆C(═O)OH, or -(C₁-C₂₄)O—C(═O)R₇C(═O)O⁻M⁺;
R₅ is C₁-C₂₄ alkyl, or C₁-C₂₄ alkyl comprising at least one alkenyl group;
R₆ is C₁-C₂₄ alkyl, or C₁-C₂₄ alkyl comprising at least one alkenyl group;
R₇ is C₁-C₂₄ alkyl, or C₁-C₂₄ alkyl comprising at least one alkenyl group; and
M is Na⁺, K⁺, Ca²⁺, Mg²⁺, Zn²⁺, or Fe⁺³.

49. The method of claim 46, wherein the mixing comprises mixing with a phase change material selected from the group consisting of: 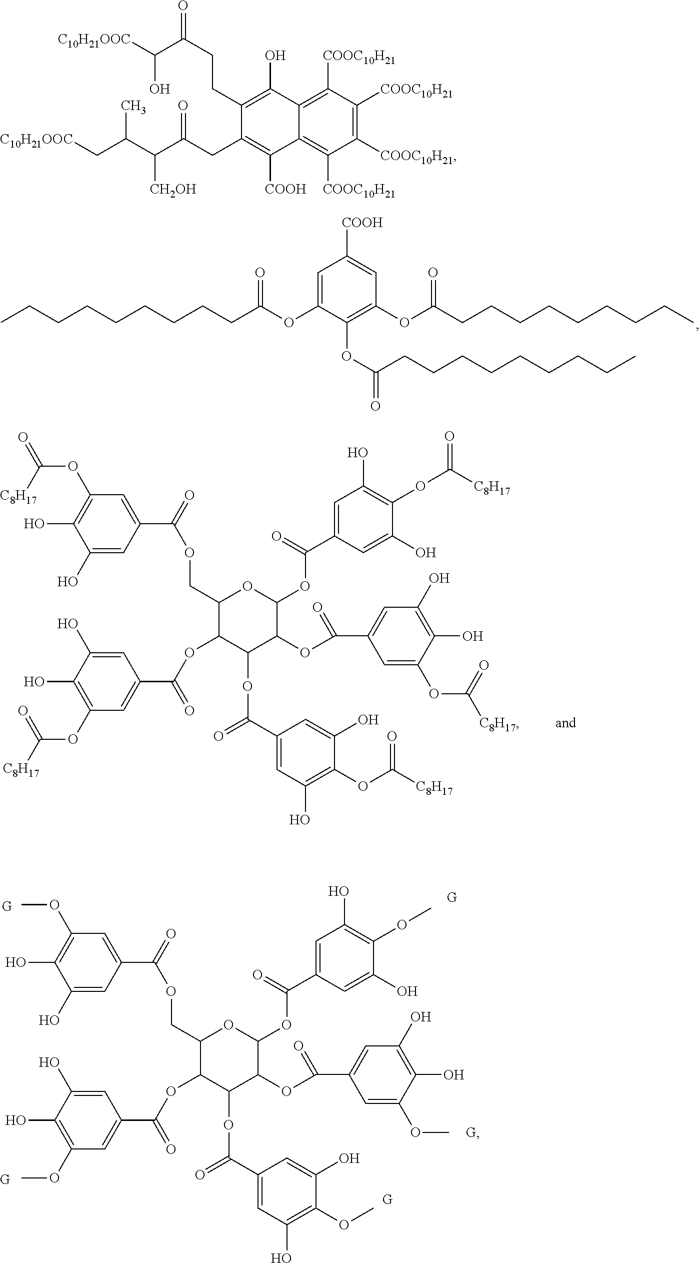
wherein G is

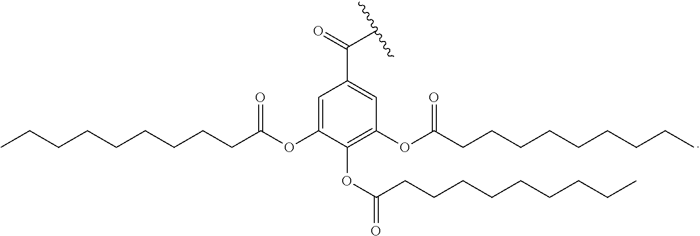 [SMILES: *C(=O)c1cc(OC(=O)CCCCCCCCC)c(OC(=O)CCCCCCCCC)c(OC(=O)CCCCCCCCC)c1]

50. The method of claim 46, wherein the mixing comprises mixing with a polymer including polyvinylacetate, cellulose, acetate, polyester, or a combination thereof.

51. The method of claim 46, wherein the mixing comprises adding the food packaging additive in an amount of about 1% to about 30% by weight of the mixture.

52. The method of claim 46, wherein the mixing comprises adding the polymer in an amount of about 70% to about 99% by weight of the mixture.

53-55. (canceled)
